(19) United States
(12) Patent Application Publication
(10) Pub. No.: US 2026/0131620 A1
(43) Pub. Date: May 14, 2026

(54) NON-CIRCULAR SHAPE VEHICLE A/C MUFFLER

(71) Applicant: Hanon Systems, Daejeon (KR)

(72) Inventors: Chao Zhang, Novi, MI (US); Robert Sorensen, Novi, MI (US); Kanwal Bhatia, Canton, MI (US); Anthony Arruda, Novi, MI (US); Eduardo Sanchez, Ave. de las Fuentes y Laguna de Tamiahua (MX); Petr Czyz, Hodslavice (CZ)

(21) Appl. No.: 18/947,479

(22) Filed: Nov. 14, 2024

(51) Int. Cl. B60H 1/00; G10K 11/20

(52) U.S. Cl. CPC B60H 1/00571; G10K 11/20; B60H 2001/006

(57) ABSTRACT

A refrigerant muffler includes a plurality of outer walls forming an outer surface of the refrigerant muffler and enclosing a hollow interior thereof with each of the respective outer walls forming a pair with an oppositely arranged one of the outer walls at opposing sides of the hollow interior. An inlet port is provided in a first one of the respective outer walls through which a refrigerant is introduced into the hollow interior of the refrigerant muffler. An outlet port is provided in a second one of the respective outer walls through which the refrigerant exits the hollow interior of the refrigerant muffler. The refrigerant muffler does not include a cross-section therethrough where the outer surface of the refrigerant muffler has a circular shape including both of the outer walls forming one of the pairs of the oppositely arranged outer walls.

### FIELD OF THE INVENTION

The invention relates to a refrigerant circuit having a refrigerant muffler incorporated therein as a noise attenuation device, and more particularly, a refrigerant muffler having a non-axially symmetric (circular) profile shape for increase a flexibility of packaging the refrigerant muffler within a corresponding vehicle while maintaining desirable noise attenuating characteristics.

### BACKGROUND

Vehicular air-conditioning systems commonly employ a compressor to circulate a refrigerant through various components of a corresponding refrigerant circuit. Such compressors tend to operate in a cyclical manner wherein the refrigerant repeatedly exits the compressor as pulses of relatively high-pressure refrigerant. These pulses of high-pressure flow can result in relatively inconsistent flow of the refrigerant through the refrigerant circuit components as well as the generation of noise that can propagate throughout such refrigerant circuit components. This noise can be undesirable to the passengers of a vehicle having such an air-conditioning system incorporated therein.

To mitigate compressor noise and to smooth out the flow of refrigerant, mufflers have been utilized in refrigerant circuits at a position immediately upstream or immediately downstream of the corresponding compressor where the refrigerant is gaseous in phase. Conventional refrigerant mufflers typically consist of a housing defining an expansion chamber having an increased flow cross-section in comparison to an inlet and an outlet of the expansion chamber. Such a conventional refrigerant muffler typically includes the expansion chamber thereof having an axially symmetric shape, such as a generally cylindrical shape. The expansion chamber, the inlet, and the outlet are provided in a specific configuration wherein acoustic waves of a specific range of frequencies reflect at an outlet end of the expansion chamber to interfere with new acoustic waves entering the expansion chamber at the inlet end thereof, thereby attenuating acoustic waves of certain preselected frequencies. The effectiveness of such refrigerant mufflers to attenuate noise at a given frequency may be measured in terms of what is referred to as the acoustic transmission loss of the associated refrigerant muffler, wherein increased transmission loss at a given frequency is associated with an improvement in the attenuation of noise, vibration, and harshness (NVH) at the given frequency. Two examples of such conventional refrigerant mufflers of the prior art are shown in FIGS. 1A and 1B. The refrigerant muffler 1 of the prior art disclosed in FIG. 1A includes a flow configuration wherein refrigerant flows axially through each of an inlet 2, an expansion chamber 3, and then an outlet 4, thereby prescribing substantially rectilinear flow of the refrigerant therethrough, wherein fluid couplings for connecting the refrigerant muffler 1 to adjacent components of the corresponding refrigerant circuit may be disposed in axial alignment with the axial direction of flow. In contrast, the refrigerant muffler 5 of the prior art disclosed in FIG. 1B includes a flow configuration wherein refrigerant flows axially through an inlet 6, turns 90 degrees when progressing axially through an expansion chamber 7, and then exits an outlet 8 while flowing in a radial direction of the refrigerant muffler 5 perpendicular to the axial direction thereof, wherein fluid couplings for connecting the refrigerant muffler 5 to adjacent components of the corresponding refrigerant circuit may be arranged to extend axially outwardly from the inlet 6 and radially outwardly from the outlet 8.

As electric vehicles become more common, so too has the use of an electrically powered scroll compressor as the compression means of an associated refrigerant circuit. Such scroll compressors typically include only one instance of high-pressure refrigerant discharge for each associated compression cycle thereof, which results in such scroll compressors generating lower frequencies of refrigerant pressure pulsations in comparison to rotary compressors having a plurality of compression chambers that each respectively generate such a pressure pulsation with respect to each complete cycle of the rotary compressor. For example, a variable displacement swash plate type compressor having five to seven compression chambers circumferentially arranged relative to a corresponding swash plate may correspondingly generate five to seven pressure pulsations via a single rotary cycle of the swash plate type compressor. It is thus necessary to provide the refrigerant muffler associated with such a scroll compressor to include the ability to attenuate noise with respect to relatively lower operating frequencies than would be the case with respect to a comparable rotary compressor.

One drawback to the use of such conventional refrigerant muffles 1, 5 in conjunction with such relatively low-frequency scroll compressors is that it is often necessary for the expansion chambers 3, 7 of such mufflers 1, 5 to be provided to include a relatively large inner diameter in order to achieve the desired acoustic transmission loss at such relatively low operating frequencies (such as frequencies of less than 200 Hz) for preventing noise from propagating to a passenger compartment of a corresponding vehicle beyond prescribed limits associated with maintaining passenger comfort. Such relatively large-diameter expansion chambers 3, 7 thus include a relatively large volume, which can present a problem whereby it is difficult to install such refrigerant mufflers 1, 5 relative to the remaining internal components of the vehicle, such as adjacent components of the associated refrigerant circuit, and especially in view of a trend towards packaging such components in a more tight configuration for reducing wasted space and potentially improving the efficiency of various systems of the vehicle where inefficient spacing may lead to unnecessary losses of energy during operation thereof. Furthermore, the axially symmetric configuration of such expansion chambers 3, 7 may be particularly problematic in terms of fitting an available packaging space as a result of the enlarged circular shape being devoid of a minimized dimension with respect to any radially extending axis through the corresponding expansion chamber 3, 7, which leads to a lack of options in reorienting such refrigerant mufflers 1, 5 to fit an available packaging space. In other words, such refrigerant mufflers 1, 5 cannot be rotated to alterative orientations whereby such refrigerant mufflers 1, 5 can be fitted within a relatively narrow gap between components that exceeds the outer diameter of the corresponding expansion chamber 3, 7, and especially in view of the fact that the axial dimension of such refrigerant mufflers 1, 5 is typically similar to or greater than the outer diameter. Incorporation of such refrigerant mufflers 1, 5 within a corresponding vehicle may thus disadvantageously require the movement or reorientation of multiple adjacent components to fit all such components within the available packaging space while maintaining desirable operation of all affected vehicle systems.

Therefore, there is a need for a refrigerant muffler that effectively suppresses noise generated by the compressor of an associated refrigerant circuit while also presenting a reduced profile leading to increased adaptability of the refrigerant muffler to reception within different packaging configurations of the associated refrigerant circuit and/or adjacent systems of a corresponding vehicle.

### SUMMARY OF THE INVENTION

In accordance with the present disclosure, a refrigerant muffler having a reduced profile and improved adaptability of design has surprisingly been discovered.

According to an embodiment of the present invention, a refrigerant muffler includes a plurality of outer walls forming an outer surface of the refrigerant muffler and enclosing a hollow interior thereof with each of the respective outer walls forming a pair with an oppositely arranged one of the outer walls at opposing sides of the hollow interior. An inlet port is provided in a first one of the respective outer walls through which a refrigerant is introduced into the hollow interior of the refrigerant muffler. An outlet port is provided in a second one of the respective outer walls through which the refrigerant exits the hollow interior of the refrigerant muffler. The refrigerant muffler does not include a cross-section therethrough where the outer surface of the refrigerant muffler has a circular shape including both of the outer walls forming one of the pairs of the oppositely arranged outer walls.

According to another embodiment of the invention, a refrigerant muffler includes six outer walls arranged into a substantially rectangular cuboid shape enclosing a hollow interior of the refrigerant muffler with the six outer walls including a first end wall and an oppositely arranged second end wall, an upper wall and an oppositely arranged lower wall, and a first lateral wall and an oppositely arranged second lateral wall, wherein each of the first lateral wall and the second lateral wall are connected around a respective periphery thereof to each of the first end wall, the second end wall, the upper wall, and the lower wall. An inlet port is provided in one of the first end wall or the upper wall through which a refrigerant is introduced into the hollow interior of the refrigerant muffler and an outlet port is provided in one of the second end wall or the first lateral wall through which the refrigerant exits the hollow interior of the refrigerant muffler. A plurality of guide walls extends between the first lateral wall and the second lateral wall with each of the plurality of the guide walls arranged in parallel and spaced apart from each other in a direction perpendicular to a direction of parallel extension of the plurality of the guide walls. Each of the plurality of the guide walls is configured to divert a flow of the refrigerant and/or to reflect acoustic waves associated with the flow of the refrigerant.

According to yet another embodiment of the invention, a refrigerant circuit includes, in an order of flow of a refrigerant during circulation thereof through the refrigerant circuit, a compressor, a refrigerant muffler, a condenser, an expansion element, and an evaporator, the refrigerant muffler including a plurality of outer walls forming an outer surface of the refrigerant muffler and enclosing a hollow interior thereof with each of the respective outer walls forming a pair with an oppositely arranged one of the outer walls at opposing sides of the hollow interior. An inlet port is provided in a first one of the respective outer walls through which a refrigerant discharged from the compressor is introduced into the hollow interior of the refrigerant muffler and an outlet port is provided in a second one of the respective outer walls through which the refrigerant exits the hollow interior of the refrigerant muffler towards the condenser. The refrigerant muffler does not include a cross-section therethrough where the outer surface of the refrigerant muffler has a circular shape comprised of both of the outer walls forming one of the pairs of the oppositely arranged outer walls.

### BRIEF DESCRIPTION OF THE DRAWINGS

FIG. 1A is a perspective view of a refrigerant muffler of the prior art having an axially symmetric configuration with refrigerant flowing axially from an inlet to an outlet thereof;

FIG. 1B is a perspective view of a refrigerant muffler of the prior art having an axially symmetric configuration with refrigerant turning 90 degrees when flowing from an inlet to an outlet thereof;

FIG. 2 is a schematic view of a generalized refrigerant circuit having a refrigerant muffler incorporated thereon;

FIG. 3 is a front perspective view of a refrigerant muffler having a non-axially symmetric outer surface according to a first embodiment of the present invention;

FIG. 4 is a front elevational view of the refrigerant muffler of FIG. 3;

FIG. 5 is an elevational cross-sectional view of the refrigerant muffler of FIG. 3 as taken from the perspective of section lines 5-5 in FIG. 4;

FIG. 6 is an elevational cross-sectional view of the refrigerant muffler of FIG. 3 as taken from the perspective of section lines 6-6 in FIG. 3;

FIG. 7 is an elevational cross-sectional view of a refrigerant muffler having a non-axially symmetric outer surface according to another embodiment of the present invention, wherein the refrigerant muffler of FIG. 7 is taken from the same perspective as FIG. 5 and includes an alternative position of an inlet port of the refrigerant muffler in comparison to the embodiment of the refrigerant muffler shown throughout FIGS. 3-6;

FIG. 8 is an elevational cross-sectional view of the refrigerant muffler of FIG. 7 as taken from the same perspective as FIG. 6 and shows the alternative position of the inlet port of the refrigerant muffler in comparison to the embodiment of the refrigerant muffler shown throughout FIGS. 3-6;

FIG. 9 is a front elevational view of a refrigerant muffler having a non-axially symmetric outer surface according to another embodiment of the present invention;

FIG. 10 is a perspective cross-sectional view of the refrigerant muffler of FIG. 9 as taken from the perspective of section lines 10-10 in FIG. 9;

FIG. 11 is a perspective view of another refrigerant muffler having a non-axially symmetric outer surface according to another embodiment of the present invention;

FIG. 12 is an elevational cross-sectional view of the refrigerant muffler of FIG. 11 as taken from the perspective of section lines 12-12 in FIG. 11;

FIG. 13 is an elevational cross-sectional view of the refrigerant muffler of FIG. 11 as taken from the perspective of section lines 13-13 in FIG. 11;

FIG. 14 is a perspective view of a refrigerant muffler having a non-axially symmetric outer surface according to another embodiment of the present invention;

FIG. 15 is a perspective cross-sectional view of the refrigerant muffler of FIG. 14 as taken from the perspective of section lines 15-15 in FIG. 14;

FIG. 16 is a chart showing the relationship between transmission loss and refrigerant pulse frequency along a range of relatively low frequencies with respect to a refrigerant muffler of the prior art and embodiments of the present invention;

FIG. 17 is a chart showing the relationship between transmission loss and frequency along an enlarged range of frequencies in comparison to FIG. 16 with respect to embodiments of the present invention;

FIG. 18 is a chart showing the relationship between pressure drop and mass flow rate with respect to a refrigerant muffler of the prior art and an embodiment of the present invention; and

FIG. 19 is a chart showing the relationship between the pressure of maximum pressure pulsations that are present along the high pressure side of a refrigerant circuit along a range of relatively low frequencies with respect to an embodiment of the present invention and a refrigerant circuit devoid of any form of refrigerant muffler.

### DETAILED DESCRIPTION OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

FIG. 2 schematically illustrates a refrigerant circuit 10 showing one possible position therealong for installing a refrigerant muffler 20 according to an embodiment of the present invention. The refrigerant circuit 10 may be incorporated into a vehicle relying upon stored electrical power to provide heat to various components of the vehicle and/or air to be delivered to the passenger cabin of the vehicle via the operation of the refrigerant circuit 10, such as an electric hybrid vehicle or electric vehicle. However, the present invention may be installed in any refrigerant circuit that is utilized for substantially any application without necessarily departing from the scope of the present invention, as the benefits of the present invention may be appreciated in any circumstances wherein noise attenuation is desirable under the conditions presented herein.

The refrigerant circuit 10 includes, in an order of flow of a refrigerant therethrough, a compressor 12, the refrigerant muffler 20, a condenser/gas cooler 13, an expansion element 15, and an evaporator/chiller 16. The compressor 12 is configured to compress and heat the refrigerant to a relatively high-temperature and high-pressure gaseous refrigerant, the condenser/gas cooler 13 is configured to transfer heat away from the gaseous refrigerant to a first heat exchange fluid in order to cool and (preferably completely) condense the refrigerant to a relatively lower temperature liquid refrigerant (or in some circumstances a liquid/gas mixture), the expansion element 15 is configured to contract and then expand the liquid refrigerant (or liquid/gas mixture) to further lower the temperature and pressure of the liquid refrigerant (or liquid/gas mixture) to produce a relatively low-temperature and low-pressure liquid refrigerant or liquid/gas mixture of low-temperature and low-pressure refrigerant, and the evaporator/chiller 16 is configured to transfer heat from a second heat exchange fluid to the low-temperature and low-pressure liquid refrigerant or liquid/gas mixture to evaporate any remaining liquid refrigerant to result in a relatively low-pressure gaseous refrigerant.

The refrigerant circuit 10, as illustrated, is simplified in form and may include any additional components or alternative flow paths associated with varying the mode of operation of the refrigerant circuit 10 while remaining within the scope of the present invention. For example, additional components that may be utilized in such a refrigerant circuit 10 may include a receiver drier (not shown) disposed between the condenser/gas cooler 13 and the expansion element 15, an accumulator (not shown) disposed between the evaporator/chiller 16 and a low-pressure side of the compressor 12, an internal heat exchanger (not shown) for exchanging heat between a portion of the refrigerant exiting the condenser/gas cooler 13 and a portion of the refrigerant exiting the evaporator/chiller 16, and/or a valve arrangement (not shown) for switching a flow direction of the refrigerant through the refrigerant circuit 10 such that the illustrated condenser/gas cooler 13 and evaporator/chiller 16 switch functions for altering the heat transfer with respect to the first and second heat exchange fluids, such as when attempting to heat air delivered to a passenger compartment of an associated vehicle or to heat or cool coolant(s) associated with various components of the vehicle in need of heating or cooling to maintain desirable operation thereof.

The refrigerant muffler 20 is disclosed as being disposed immediately downstream of the compressor 12 to receive a flow of the relatively high-pressure, gaseous refrigerant after exiting the high-pressure (discharge) side of the compressor 12. The refrigerant muffler 20 may be provided at the disclosed position to ensure that the refrigerant passing therethrough is gaseous in form to provide preferable conditions for attenuating noise originating from the refrigerant. However, the refrigerant muffler 20 is not necessarily limited to receiving the high-pressure discharge refrigerant, and may alternatively be positioned immediately upstream of the compressor 12 in order to receive the relatively low-pressure, gaseous form of the refrigerant prior to the refrigerant entering the compressor 12 via the low-pressure (suction) side thereof without necessarily departing from the scope of the present disclosure.

The present disclosure includes multiple related embodiments of the refrigerant muffler 20 that are identified hereinafter with the reference numeral “20” followed by a letter assigned in the order of description of such embodiments of the refrigerant muffler 20 herein. Each such refrigerant muffler may also be referred to hereinafter simply as a “muffler” for brevity.

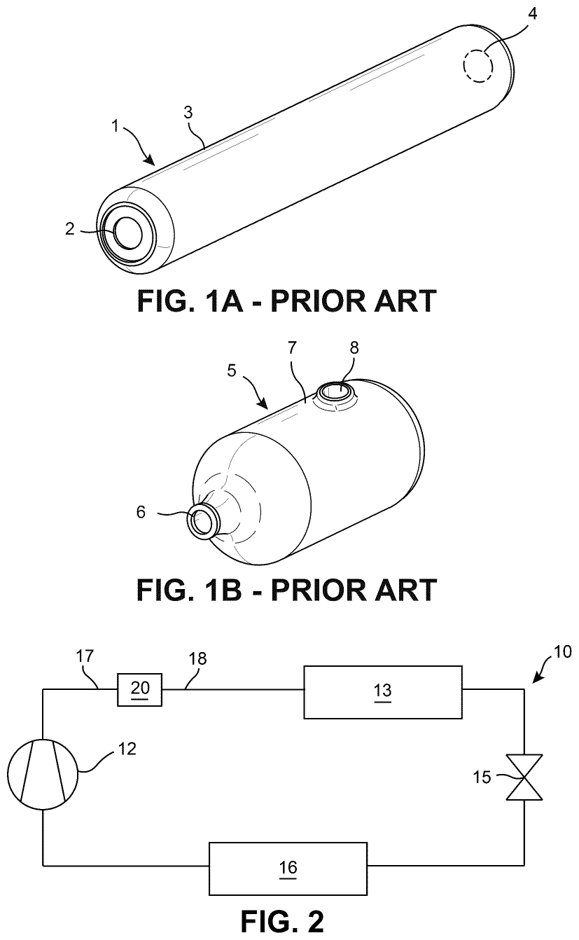

The embodiments of the muffler 20 disclosed herein all share certain characteristics that promote the ability of such mufflers 20 to be received within a relatively small or spatially constrictive packaging space within a vehicle. Additionally or alternatively, the presently disclosed mufflers 20 share certain characteristics that promote the ability of such mufflers 20 to maximize the desirable characteristics thereof in comparison to the conventional mufflers of the prior art with respect to a given packaging configuration sized and dimensioned for receiving such conventional mufflers, such as the mufflers 1, 5 shown and described in the present background of the invention. For example, with reference to the muffler 1 of the prior art of FIG. 1A, a rectangular cuboid packaging space may not be dimensioned to receive the elongate muffler 1 therein when the muffler 1 is extended longitudinally in parallel to the longitudinal direction of the rectangular cuboid shape, but may be able to fit within such a space when the muffler 1 is disposed at an incline relative to the longitudinal direction with the opposing ends (corresponding to the inlet 2 and outlet 3 thereof) of the muffler 1 disposed towards two of the opposing interior corners or corner edges of the rectangular cuboid shape. Such an arrangement of the muffler 1 thus results in the formation of open spaces at any remaining interior corners or corner edges of the rectangular cuboid shape, wherein such spaces may not be shaped or dimensioned to easily receive additional components therein, thereby resulting in wasted packaging space in accommodating the elongate shape of the muffler 1. A similar circumstance may also be faced with respect to the muffler 5 when attempting to position and orient the muffler 5 in a desired packaging space for the same reasons, and furthermore because the enlarged diameter of the muffler 5 presents especially large open spaces within such a rectangular cuboid packaging space at those positions where the circumference of the muffler 5 is angularly displaced from any of the boundaries of the cuboid shape.

Under circumstances where such packaging space is available and is at least partially wasted via the inefficient configuration of such mufflers 1, 5 within the packaging space, it is thus an object of the present invention to provide the muffler 20 in a configuration that minimizes or eliminates such wasted space while utilizing this newly utilized space to improve various properties of the muffler 20, thereby maximizing the efficiency of the refrigerant circuit 10 as well as the packaging of the vehicle components. For example, it is an object of the present invention for each of the disclosed embodiments of the muffler 20 to improve upon one or more of the acoustic transmission loss of the muffler 20 (corresponding to a reduction in noise propagation) with respect to expected frequencies of acoustic waves as generated by a corresponding frequency of the compressor 12 during expected modes of operation thereof, the pressure drop experienced within a refrigerant when passing through the muffler 20, the strength and/or durability of the muffler 20 to withstand sustained or periodic periods of high internal pressure as supplied by the refrigerant passing therethrough, and/or the material usage, weight, cost, ease of assembly, or other concerns associated with the manufacture of the muffler 20. Where inclusion of certain features within the muffler 20 is found to result in an inverse relationship with respect to any of the above properties, such as an improvement in transmission loss coupled with a degradation regarding the pressure drop experienced across the muffler 20, it is an object of the invention to maximize the improved property while minimizing any resulting negative properties such that the muffler 20 still maintains acceptable characteristics in accordance with acceptable operation of the muffler 20 and the corresponding refrigerant circuit 10.

Each of the mufflers 20 shown and described hereinafter share the same general configuration corresponding to close fitting reception of each such muffler 20 within a substantially rectangular cuboid packaging space while minimizing the open (wasted) space within such a packaging space. This is accomplished by means of each of the mufflers 20 disclosed herein generally including a shape of the outer surface thereof that is formed into a correspondingly rectangular cuboid shape having six major sides that cooperate to form the described shape. The six sided shape includes four contiguous sides of the six total sides forming a closed and substantially rectangular or rounded rectangular shape when progressing around one of three perpendicular axes extending through the muffler 20 and corresponding to the three major dimensional directions of the muffler 20, such as the three axes corresponding to a length direction L, a height direction H, and a width direction W of the muffler 20. As utilized herein, the width direction W always refers to a direction measuring a minor dimension of the rectangular cuboid shape as defined between the two most closely spaced set of opposing sides among the three different sets of sides forming the six sided shape, while the length direction L and the height direction H each correspond to directions for measuring relatively larger respective dimensions of the rectangular cuboid shape than the width dimension, with each of the larger dimensions defined between a set of two opposing sides that are respectively spaced apart by a farther distance than the two opposing sides defining the width dimension. In the provided embodiments, the length dimension and the height dimension are shown as significantly exceeding the width dimension to result in a relatively narrow rectangular cuboid shape, such as each of the length dimension and the height dimension being at least two times as great as the width dimension, being at least three times as great as the width dimension, being at least four times as great as the width dimension, or being at least five times as great as the width dimension, in accordance with the objective of the present invention in adapting such a muffler 20 for installation into a relatively narrow gap within a vehicle packaging space.

It should be noted that although the length direction L is generally shown in the representative embodiments as corresponding to a greater dimension than the dimension of the height direction H, it is not necessarily the case that the identified length dimension will always exceed the identified height dimension, hence the naming of the length direction L as such does not imply that the length dimension is necessarily the largest major dimension of the rectangular cuboid shape of each disclosed muffler 20. It is thus conceivable that the length dimension and the height dimension may be equal, or the height dimension may in some circumstances exceed the length dimension without necessarily departing from the scope of the present invention. The length direction L may alternatively be referred to simply as the first direction, the height direction H may alternatively be referred to simply as the second direction, and the width direction may be referred to simply as the third direction.

References to a feature extending in a given direction L, H, W or references to a refrigerant flowing in a given direction do not necessarily indicate that such extension or flow occurs in one specific direction as may be defined by an origin of a corresponding coordinate system, but may refer to such features extending or flowing in either of two opposing directions arranged parallel to or extending along such identified directions L, H, W. Where necessary to define a direction of extension or flow with respect to one of the two opposing directions associated with one of the identified directions L, H, W corresponding to the primary axes of the muffler 20, further reference is made herein to the relationship present between relevant features of the muffler 20 for identifying which of the opposing directions is intended, such as identifying that a specific direction of extension or flow extends from a first side/wall to a second side/wall with such first and second sides/walls identified in the present drawings.

The use of the height direction H for defining one relatively large dimension of the muffler 20 also does not necessarily indicate that the disclosed muffler 20 is intended to be limited to being disposed upright with the height direction H corresponding to a vertical direction, as the beneficial features of the muffler 20 are not dependent on the orientation the muffler 20 relative to the direction of gravity due to the pressurization of the refrigerant passing through the muffler 20 and the available flow paths through the muffler 20 primarily influencing the manner of operation of the muffler 20 regardless of the spatial orientation thereof. Such terms are used merely in easily identifying the necessary directions and dimensions with reference to the associated drawings, which all depict the height direction as being substantially vertically oriented. Similarly, terms utilized herein that refer to relationships occurring with respect to a vertical direction, such as referring to sides or walls as being upper, top, lower, or bottom sides or walls or referring to components or features being disposed above or below one another, are not intended to limit the possible orientations of the muffler 20 within the packaging space of the vehicle on the basis of the use of such terms.

In accordance with the above definitions, each of the mufflers 20 disclosed herein according to the present invention includes six major sides thereof with each of the six major sides identified as a distinct wall of the corresponding muffler 20, wherein such walls are identified using common reference numerals throughout the different embodiments disclosed herein for ease of understanding when referring to the associated drawing figures. The six major walls of each disclosed muffler include a first end wall 21, a second end wall 22, an upper wall 23, a lower wall 24, a first lateral wall 25, and a second lateral wall 26. When alternatively referencing all six walls independent of the assigned spatial or directional identifiers, the first end wall 21 may be referred to as the first wall 21, the second end wall 22 may be referred to as the second wall 22, the upper wall 23 may be referred to as the third wall 23, the lower wall 24 may be referred to as the fourth wall 24, the first lateral wall 25 may be referred to as the fifth wall 25, and a second lateral wall 26 may be referred to as the sixth wall 26.

The first end wall 21 is formed opposite the second end wall 22 with the end walls 21, 22 spaced apart from each other by the length direction L. The first end wall 21 and the second end wall 22 each respectively extend primarily in the height direction H and the width direction W of the corresponding muffler 20. The end walls 21, 22 are positioned to each respectively extend between and connect to each of the lateral walls 25, 26 along respective edges of the muffler 20 extending in the height direction H thereof, and the end walls 21, 22 are also positioned to each respectively extend between and connect to each of the upper and lower walls 23, 24 along respective edges of the muffler 20 extending in the width direction W thereof. Each of the end walls 21, 22 is substantially rectangular or rounded rectangular in perimeter shape with a major dimension in the height direction H and a minor dimension in the width direction W. In some embodiments, at least a portion of each of the respective end walls 21, 22 is disposed on or along a plane extending exclusively in the height and width directions H, W, and/or includes an inner or outer surface thereof arranged on a plane extending exclusively in the height and width directions H, W.

The upper wall 23 is formed opposite the lower wall 24 with the upper and lower walls 23, 24 spaced apart from each other by the height direction H. The upper wall 23 and the lower wall 24 each respectively extend primarily in the length direction L and the width direction W of the corresponding muffler 20. The upper and lower walls 23, 24 are positioned to each respectively extend between and connect to each of the lateral walls 25, 26 along respective edges of the muffler 20 extending in the length direction L thereof, and the upper and lower walls 23, 24 are also positioned to each respectively extend between and connect to each of the end walls 21, 22 along respective edges of the muffler 20 extending in the width direction W thereof. Each of the upper and lower walls 23, 24 is substantially rectangular or rounded rectangular in perimeter shape with a major dimension in the length direction L and a minor dimension in the width direction W. In some embodiments, at least a portion of each of the respective upper and lower walls 23, 24 is disposed on or along a plane extending exclusively in the length and width directions L, W, and/or includes an inner or outer surface thereof arranged on a plane extending exclusively in the length and width directions H, W.

The first lateral wall 25 is formed opposite the second lateral wall 26 with the end walls 25, 26 spaced apart from each other by the width direction W. The first lateral wall 25 and the second lateral wall 26 each respectively extend primarily in the height direction H and the length direction L of the corresponding muffler 20. The lateral walls 25, 26 are positioned to each respectively extend between and connect to each of the end walls 21, 22 along respective edges of the muffler 20 extending in the height direction H thereof, and the lateral walls 25, 26 are also positioned to each respectively extend between and connect to each of the upper and lower walls 23, 24 along respective edges of the muffler 20 extending in the length direction L thereof. Each of the lateral walls 25, 26 is substantially rectangular or rounded rectangular in perimeter shape with a major dimension in the length direction L or height direction H, depending on the associated configuration of the muffler 20 as explained above, although the present figures depict the major dimension as being the length dimension. In some embodiments, at least a portion of each of the respective lateral walls 25, 26 is disposed on or along a plane extending exclusively in the height and width directions H, W, and/or includes an inner or outer surface thereof arranged on a plane extending exclusively in the height and width directions H, W.

As utilized herein, each of the described walls 21, 22, 23, 24, 25, 26 being described as extending “primarily” in any two of the identified directions L, H, W indicates that the corresponding wall 21, 22, 23, 24, 25, 26 includes greater dimensions of extension between the opposing peripheral edges thereof with respect to the two directions identified as the primary extension directions in comparison to the non-identified direction, such as where the respective wall includes curved or inclined portions or surfaces that are not exclusively parallel to or exclusively disposed along a plane defined by the two directions of primary extension associated with the corresponding wall 21, 22, 23, 24, 25, 26 in question such that the corresponding wall 21, 22, 23, 24, 25, 26 may extend slightly or partially in a direction that is not one of the two identified primary directions of extension. For example, wherein a semi-circular wall shape includes opposing ends separated from each other by the width direction W with the shape extended longitudinally in the height direction H (at a distance in the height direction H that is greater than the distance between the opposing ends of the semi-circular shape) to form the resulting wall, such a wall would refer to one of the identified end walls 21, 22 by virtue of the spacing between opposing ends of a semi-circular shape being twice as far apart as the direction of extension of the arcuate wall as measured along the length direction L from one of the opposing ends of the semi-circular shape to a distal and central point of the semi-circular shape. Accordingly, such an arcuate shape provided in any of the identified walls 21, 22, 23, 24, 25, 26 may, despite such curvature, still be said to form one of the six sides or six outer walls of the resulting rectangular cuboid shape in accordance with the present invention.

Where any such wall 21, 22, 23, 24, 25, 26 meets another wall 21, 22, 23, 24, 25, 26 along one of the identified connecting edges with a 45 degree chamfer or a fillet having a constant radius of curvature to form a transition between the adjoining walls 21, 22, 23, 24, 25, 26, a boundary between the adjoining walls 21, 22, 23, 24, 25, 26 for identifying which portions of the muffler 20 constitutes which of the walls 21, 22, 23, 24, 25, 26 may be selected as a midpoint along the chamfer or fillet, such as the boundary being equally spaced from each of the opposing edges of the chamfer, or the boundary being associated with half the angle of arcuate extension of the fillet or other transitioning surface, such as the boundary being associated with the 45 degree angular position of a surface having a constant radius of curvature through 90 degrees of angular displacement. One example of such a boundary B is shown with reference to an arcuate transition of constant curvature between the first lateral wall 25 and the upper wall 23 in FIG. 4 where the arcuate transition is divided in half via the 45 degree angled boundary B, wherein portions of the transition disposed above the boundary B (shown as a broken line) correspond to the upper wall 23 and portions of the transition disposed below the boundary B correspond to the first lateral wall 25.

The rectangular cuboid shape of the muffler 20 may also be described as not being axially symmetric with respect to any set of four of the arranged walls 21, 22, 23, 24, 25, 26 that cooperate to extend around an axis arranged parallel to any of the three identified directions L, H, W in forming a closed shape, wherein such a closed shape is instead generally rectangular or rounded rectangular in accordance with the cuboid shape of the muffler 20. Each embodiment of the muffler 20 thus does not include an inner surface or outer surface thereof that extends along multiple of the walls 21, 22, 23, 24, 25, 26 in combination and that includes a full circular cross-sectional shape in the same manner as the conventional mufflers 1, 5 of the prior art as identified in FIGS. 1A and 1B. Each such muffler 20 may also be said to not include an axially symmetric inner or outer surface formed by the cooperation or combination of three or more of the walls 21, 22, 23, 24, 25, 26 forming a closed shape that extends through greater than 180 degrees of curvature with respect to a constant radius of curvature as measured relative to a common axis equally spaced from such a curved surface. As mentioned above, a 90 degree transition or an entire wall 21, 22, 23, 24, 25, 26 of semi-circular shape with 180 degrees of constant curvature would not be considered to be an axially symmetric surface in accordance with the definitions set forth herein. Any surface of the muffler 20 formed by the cooperation of any four such walls 21, 22, 23, 24, 25, 26 is thus not cylindrical in shape in the same manner as the mufflers 1, 5 of the prior art in accordance with the present invention.

Each of the disclosed mufflers 20 may be said to include a “substantially” rectangular cuboid shape as defined or established by each of the identified walls 21, 22, 23, 24, 25, 26, which may be referred to as the “outer” walls 21, 22, 23, 24, 25, 26 of the corresponding muffler 20, meeting the requirements set forth herein regarding the configuration of each respective wall 21, 22, 23, 24, 25, 26 as well as the requirements described regarding the relationships present between each of the walls 21, 22, 23, 24, 25, 26 and the remaining walls 21, 22, 23, 24, 25, 26. Such requirements include each of the walls 21, 22, 23, 24, 25, 26 forming one of the six sides of the substantially rectangular cuboid shape being formed opposite another one of the six walls 21, 22, 23, 24, 25, 26 forming another one of the six sides of the rectangular cuboid shape with both walls 21, 22, 23, 24, 25, 26 forming each of the three different pairs respectively extending primarily in the specified pair of directions L, W, H, each of the walls 21, 22, 23, 24, 25, 26 connecting to four adjoining walls 21, 22, 23, 24, 25, 26 around a periphery of the corresponding one of the walls 21, 22, 23, 24, 25, 26, and one of the pairs of the opposing walls 21, 22, 23, 24, 25, 26 being spaced apart from each other by a minor dimension of the rectangular cuboid shape when compared to the spacing of the remaining pairs of walls 21, 22, 23, 24, 25, 26 from each other with respect to the remaining directions/dimensions. Each of the mufflers 20 may alternatively be considered to be “substantially” rectangular cuboid in shape where each of eight corners of the muffler 20, each of which correspond to a position where the edges of three of the walls 21, 22, 23, 24, 25, 26 meet each other, cooperate to correspond to the positions of eight corners bounding an associated rectangular cuboid shape. Any such muffler 20 disclosed herein that includes rounded, curved, or otherwise transitioned edges and/or corners and meets the above conditions for being considered to be “substantially rectangular cuboid” in shape may additionally be considered to be “substantially rounded-rectangular cuboid” in shape in accordance with the present invention.

As utilized hereinafter, the inner surface of each of the walls 21, 22, 23, 24, 25, 26 is identified with the reference numeral of the associated wall 21, 22, 23, 24, 25, 26 with a trailing letter “a” while the opposing outer surface of each of the walls 21, 22, 23, 24, 25, 26 is identified with the reference numeral of the associated wall 21, 22, 23, 24, 25, 26 with a trailing letter “b”, and such naming convention is utilized among all such disclosed embodiments for clarity and ease of reference. Each of the mufflers 20 identified herein includes the inner surfaces 21a, 22a, 23a, 24a, 25a, 26a of the six outer walls 21, 22, 23, 24, 25, 26 cooperating to form a hollow interior 30 of the corresponding muffler 20 through which a refrigerant passes when flowing through the corresponding muffler 20, wherein the hollow interior 30 of each such muffler 20 may also be referred to as being substantially rectangular cuboid or being substantially rounded-rectangular cuboid in shape in accordance with the status of the walls 21, 22, 23, 24, 25, 26 forming the hollow interior 30 also meeting the necessary requirements set forth above. As mentioned earlier, no combination of any of the adjoining outer surfaces 21b, 22b, 23b, 24b, 25b, 26b of the walls 21, 22, 23, 24, 25, 26 cooperate with each other to form any type of axially symmetric (circular cross-sectional) shape, and more narrowly none of the adjoining outer surfaces 21b, 22b, 23b, 24b, 25b, 26b of the walls 21, 22, 23, 24, 25, 26 cooperate with each other to form greater than 180 degrees of rotation of a given shape about a common axis of curvature for establishing a major portion (over half) of such an axially symmetric shape.

The hollow interior 30 of each corresponding muffler 20 is fluidly coupled to the associated refrigerant circuit 10 via each of an inlet port 35 and an outlet port 36, each of which is provided as a respective opening passing through the thickness of a corresponding one of the walls 21, 22, 23, 24, 25, 26 to the inner surface 21a, 22a, 23a, 24a, 25a, 26a of the corresponding one of the walls 21, 22, 23, 24, 25, 26 such that refrigerant may enter the hollow interior 30 by way of the inlet port 35 and may exit the hollow interior 30 by way of the outlet port 36. With reference back to FIG. 2, the inlet port 35 may be sealingly coupled to an associated fluid line 17 of the refrigerant circuit 10 by means of any desired method, fitting, coupling, interface, or the like for establishing a sealed connection of the fluid line 17 to the inlet port 35 while the outlet port 36 may similarly be sealingly coupled to an associated fluid line 18 of the refrigerant circuit 10 by means of any desired method, fitting, coupling, interface, or the like for establishing a sealed connection of the fluid line 18 to the outlet port 36. All of the illustrated inlet ports 35 and outlet ports 36 of the present figures are shown as being circular in profile and cross-sectional shape, although alternative configurations may be utilized without departing from the scope of the present invention. The inlet port 35 of each disclosed embodiment of the muffler 20 is generally located towards or within a quadrant of the rectangular cuboid shaped muffler 20 having a junction of the first end wall 21 and the upper wall 23 while the outlet port 36 of each disclosed embodiment of the muffler 20 is generally located towards or within a quadrant of the rectangular cuboid shaped muffler 20 having a junction of the second end wall 22 and the lower wall 24, thereby presenting a spacing of the inlet port 35 from the outlet port 36 in a direction generally extending diagonally across the muffler 20 at an incline with respect to the length direction L and the height direction H.

In each illustrated embodiment, the inlet port 35 is formed in either of the first end wall 21 or the upper wall 23 within or at a boundary of the above-mentioned quadrant of the corresponding muffler 20, wherein formation of the inlet port 35 in the first end wall 21 corresponds to the refrigerant entering the hollow interior 30 while flowing primarily in the length direction L towards the second end wall 22 and formation of the inlet port 35 in the upper wall 23 corresponds to the refrigerant entering the hollow interior 30 while flowing primarily in the height direction H towards the lower wall 24. The outlet port 36 is shown in each illustrated embodiment as being formed in either of the second end wall 22 or one of the lateral walls 25, 26 at a position adjacent the junction of the second end wall 22 and the lower wall 24, wherein formation of the outlet port 36 in the second end wall 22 corresponds to the refrigerant exiting the hollow interior 30 while flowing primarily in the length direction L towards the second end wall 22 and formation of the outlet port 36 in one of the lateral walls 25, 26 corresponds to the refrigerant exiting the hollow interior 30 while flowing primarily in the width direction W following a substantially 90 degree turn of the refrigerant after flowing primarily in the length direction L towards the second end wall 22, the height direction H towards the lower wall 24, or at an incline corresponding to partial flow in each designated direction L, H. Although not shown herein, it is conceivable that certain embodiments of the muffler 20 may include the inlet port 35 formed in one of the lateral walls 25, 26 adjacent the junction of the first end wall 21 and the upper wall 23 within the identified quadrant of the inlet port 35 and/or the muffler 20 may include the outlet port 36 formed in the lower wall 24 within the identified quadrant of the outlet port 36 without necessarily departing from the scope of the present invention. Such modifications to the positioning of either of the inlet port 35 or the outlet port 36 may be facilitated by a need for a different mounting configuration of the muffler 20 relative to the fluid lines 17, 18, and may in some circumstances result in the need to modify certain aspects of the invention relating to the attenuation of noise within the muffler 20, such as modifying the dimensions of certain features or the dimensions of the spacing between certain features in tuning the structure of the muffler 20 to attenuate the noise with respect to certain flow rates or frequencies of operation of the compressor 12.

Each of the mufflers 20 disclosed herein includes the refrigerant flowing primarily in one of the length direction L or the height direction H when traversing the hollow interior 30 with the opposing inner surfaces 25a, 26a of the lateral walls 25, 26 acting to delimit lateral flow of the refrigerant in the width direction W. The relatively small dimension of each muffler 20 in the width direction W as defined between the opposing lateral walls 25, 26 may be utilized to minimize the lateral expansion and subsequent lateral contraction of the refrigerant in the width direction W upon entering and then exiting the hollow interior 30 via the inlet port 35 and the outlet port 36, respectively, thereby limiting the pressure loss associated with such sequential expansion and contraction of a fluid. Because the lateral walls 25, 26 extend primarily in the length and height directions L, H, the refrigerant flow through the hollow interior 30 is substantially parallel to each of the opposing inner surfaces 25a, 26a of the lateral walls 25, 26 regardless of whether the refrigerant is instantaneously flowing in the length direction L, the height direction H, or at incline comprising partial flow in both the length and height directions L, H.

The embodiments of the present invention rely upon the cyclical acoustic waves carried by the flow of the refrigerant when entering the muffler 20 being reflected off of various surfaces disposed within the hollow interior 30 such that destructive interference of the acoustic waves occurs when such reflective surfaces are positioned relative to one another such that wave peaks and wave valleys meet and cancel each other out, whereby this effect generally varies according to the frequency of the acoustic waves entering the muffler 20. In many situations, a majority of the refrigerant tends to flow along certain flow paths or along certain regions of available flow paths through the hollow interior 30 where the energy loss (resulting in pressure loss) of the refrigerant is minimized, hence it is not uncommon for the refrigerant flow rate to vary within the hollow interior 30 based on factors such as the distance the refrigerant flows and/or the number of changes of direction of the refrigerant along a given flow path through the hollow interior 30 between the inlet port 35 and the outlet port 36. The acoustic waves carried by the refrigerant tend to propagate throughout the hollow interior 30 including along flow paths therein that are relatively stagnant with respect to the flow of the refrigerant from the inlet port 35 to the outlet port 36, thereby allowing for the muffler 20 to utilize a specific configuration suited for the cancellation of such acoustic waves without having to introduce an excessive pressure drop in the refrigerant in accordance with the configuration of the tuned reflective surfaces.

Each of the mufflers 20 disclosed herein accordingly includes a plurality of internal guide walls 40 formed within the hollow interior 30 that together with the inner surfaces 21a, 22a, 23a, 24a, 25a, 26a of the walls 21, 22, 23, 24, 25, 26 act to both guide a flow of the refrigerant passing thereover and to provide reflective surfaces within the hollow interior 30 for prescribing the desired opposing motion of the acoustic waves against oncoming acoustic waves in a manner leading to the destructive interference thereof, and especially with respect to certain desirable frequencies of such acoustic waves passing through the muffler 20. Each of the guide walls 40 disclosed herein is connected to and extends inwardly relative to at least two of the oppositely arranged inner surfaces 21a, 22a, 23a, 24a, 25a, 26a of a first one of the opposing pairs of the walls 21, 22, 23, 24, 25, 26, and may additionally be connected to one or both of the oppositely arranged inner surfaces 21a, 22a, 23a, 24a, 25a, 26a of another second one of the opposing pairs of the walls 21, 22, 23, 24, 25, 26 arranged perpendicular to the first one of the opposing pairs. For example, such guide walls 40 may extend between and connect to the inner surfaces 25a, 26a of the lateral walls 25, 26 while also extending to and connecting to one or both of the inner surfaces 21a, 22a of the end walls 21, 22 or one or both of the inner surfaces 23a, 24a of the upper and lower walls 23, 24, depending on the instantaneous configuration.

Each of the guide walls 40 includes a first major surface 41 and an opposing second major surface 42 with a thickness of each such guide wall 40 defined between the opposing major surfaces 41, 42. The first major surface 41 of each guide wall 40 refers to a surface thereof facing outwardly towards one of the first end wall 21 or the upper wall 23 such that refrigerant exiting the inlet port 35 encounters (strikes) or passes by or beyond the first major surface 41 prior to encountering (striking) or passing by or beyond the second major surface 42 when flowing towards the outlet port 36, hence the first major surface 41 may be referred to as the leading major surface 41 of each such guide wall 40 while the second major surface 42 may be referred to as the trailing major surface 42 of each such guide wall 40.

Each of the guide walls 40 further includes at least one connecting surface 43 for connecting the first major surface 41 thereof to the second major surface 42 thereof with respect to the thickness direction of the corresponding guide wall 40. In some circumstances, one of the connecting surfaces 43 is formed by an end surface 44 of the corresponding guide wall 40 where the corresponding guide wall 40 terminates with respect to a direction of extension of the major surfaces 41, 42 thereof with the corresponding end surface 44 also being spaced apart from a facing one of the inner surfaces 21a, 22a, 23a, 24a, 25a, 26a of one of the walls 21, 22, 23, 24, 25, 26 or a facing one of the surfaces 41, 42, 43 of another of the guide walls 40, and in other circumstances the connecting surface 43 defines an opening 50 formed through the corresponding guide wall 40 in the thickness direction thereof between the opposing major surfaces 41, 42 thereof such that refrigerant or acoustic waves can pass from one major surface 41, 42 to the other major surface 41, 42 of the corresponding guide wall 40 by way of the opening 50 therethrough.

The inclusion of the guide walls 40 within the hollow interior 30 results in the formation of a plurality of passageways 45 through the hollow interior 30 as defined by any of one of the openings 50 through one of the guide walls 40, a space disposed between one of the surfaces 41, 42, 44 of one of the guide walls 40 and a facing inner surface 21a, 22a, 23a, 24a, 25a, 26a of one of the outer walls 21, 22, 23, 24, 25, 26 or a space disposed between one of the surfaces 41, 42, 44 of two adjacent disposed ones of the guide walls 40. Each of the passageways 45 that is formed between two adjacent disposed guide walls 40 or a guide wall 40 and a facing wall 21, 22, 23, 24, 25, 26 is also understood to be defined by the opposing lateral walls 25, 26 extending along all such passageways 45. Each of the passageways 45 allows for the passage of the flow of the refrigerant therethrough when flowing from the inlet port 35 towards the outlet port 36 and/or allows the passage of any propagating acoustic waves therethrough when moving towards or reflecting back from a corresponding reflective surface as defined by one of the surfaces 41, 42, 43 of one of the guide walls 40 or one of the inner surfaces 21a, 22a, 23a, 24a, 25a, 26a of one of the walls 21, 22, 23, 24, 25, 26. Depending on the circumstances, the passageways 45 of the disclosed embodiments may be arranged such that the refrigerant and/or acoustic waves pass through a plurality of the passageways 45 in sequential order when moving through the hollow interior 30, such as when progressing from the inlet port 35 towards the outlet port 36, or the passageways 45 may be arranged such that the refrigerant and/or acoustic waves are divisible for distribution to one of a plurality of possible passageways 45 when moving through the hollow interior 30, again such as when progressing from the inlet port 35 towards the outlet port 36. The hollow interior 30 of each such muffler 20 may include one or more manifold spaces 60 where multiple different passageways 45 are aligned with each other along an axis, such as an axis extending in the length or height directions L, H, that is in turn fluidly coupled to a plurality of transverse oriented and branching passageways 45 such that refrigerant or acoustic waves can be distributed to the plurality of the different transverse oriented and branching passageways 45 via flow through one of the manifold spaces 60. A flow of the refrigerant and/or propagation of an acoustic wave from one of the passageways 45 to another of the passageways 45 includes a 90 degree change of direction thereof, such as a change of direction between moving primarily in the length direction L or the height direction H before turning to moving primarily in the other of the length direction L or the height direction H.

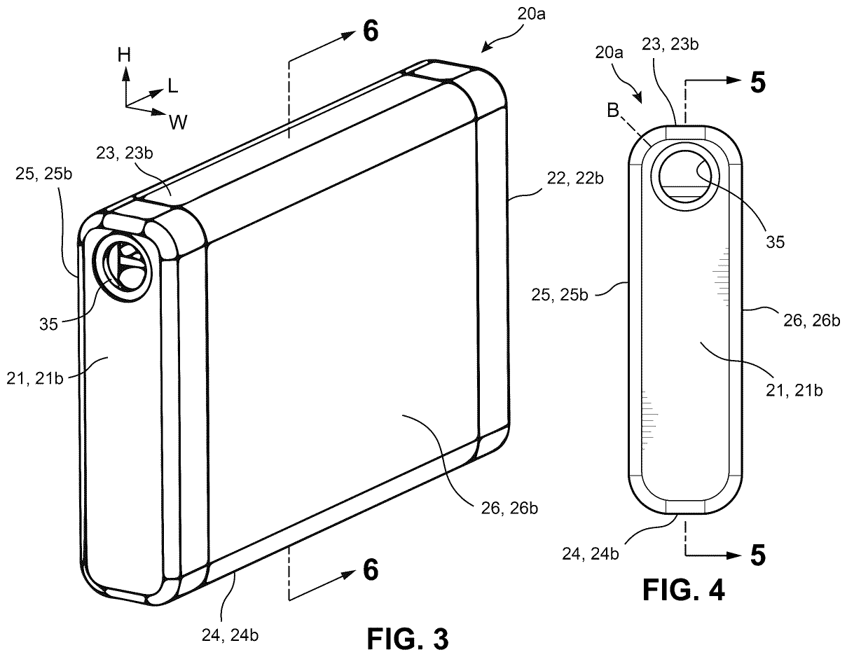

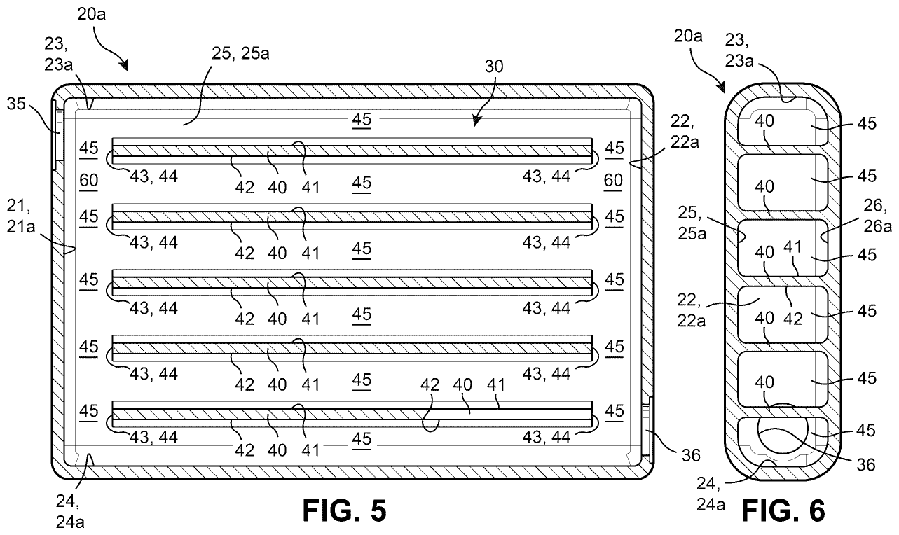

FIGS. 3-6 illustrate a muffler 20a according to a first embodiment in accordance with the description of the muffler 20 more generally hereinabove. The muffler 20a includes the inlet port 35 provided in the first end wall 21 adjacent the junction thereof with the upper wall 23 and the outlet port 36 thereof provided in the second end wall 22 adjacent the junction thereof with the lower wall 24 such that the refrigerant enters and exits the muffler 20a while flowing primarily in the length direction L.

The hollow interior 30 of the muffler 20a includes an array of a plurality of the guide walls 40 disposed therein with each of the guide walls 40 extending laterally between and connected to the inner surfaces 25a, 26a of the opposing lateral side walls 25, 26 with the major surfaces 41, 42 of each of the guide walls 40 extending primarily in the length and width directions L, W, thereby resulting in the major surfaces 41, 42 of the array of guide walls 40 being arranged parallel to one another as well as the inner surfaces 23a, 24a of the upper and lower walls 23, 24. Each of the guide walls 40 may include an arcuate transition with the inner surface 25a, 26a of each of the adjoining lateral walls 25, 26 to prevent the formation of sharp corners within the hollow interior 30. The array of the guide walls 40 includes five such guide walls 40, but it should be understood that fewer or greater such guide walls 40 may be utilized without departing from the scope of the present invention. Each of the guide walls 40 is spaced apart from another one of the guide walls 40 or a facing one of the upper or lower walls 23, 24 with respect to the height direction H. In the present embodiment, each of the guide walls 40 is spaced apart from an adjacent one of the guide walls 40 of the array by a common spacing in the height direction H while the endmost guide walls 40 of the array are spaced apart a slightly smaller distance from a facing respective one of the upper or lower walls 23, 24 than the common distance of spacing between the adjacent disposed guide walls 40.

Each of the guide walls 40 includes opposing connecting surfaces 43 arranged to extend in the height direction H, each of which is provided as one of the end surfaces 44 of the corresponding guide wall 40. A first one of the end surfaces 44 of each of the guide walls 40 is spaced apart from the inner surface 21a of the first end wall 21 and a second one of the end surfaces 44 of each of the guide walls 40 is spaced apart from the inner surface 22a of the second end wall 22, wherein each of the guide walls 40 includes a common spacing from each of the respective end walls 21, 22 such that each of the guide walls 40 includes the same positioning along the length direction L, which also results in the alignment of all of the end surfaces 44 at each end of the array of the guide walls 40 being aligned along a common plane extending in the height and width directions H, W. This arrangement of the guide walls 40 results in a first one of the manifold spaces 60 being formed between the array of the guide walls 40 and the inner surface 21a of the first end wall 21 and a second one of the manifold spaces 60 being formed between the array of the guide walls 40 and the inner surface 22a of the second end wall 22, wherein each such manifold space 60 includes the alignment of a plurality of the passageways 45 as formed between a respective one of the inner surfaces 21a, 22a and a facing one of the end surfaces 44 of one of the guide walls 40. Each of the manifold spaces 60 formed to each end of the array of the guide walls 40 allows for refrigerant flow or acoustic waves to be distributed to or combined from a plurality of passageways 45 formed between adjacent ones of the guide walls 40 or one of the guide walls 40 and one of the inner surfaces 23a, 24a.

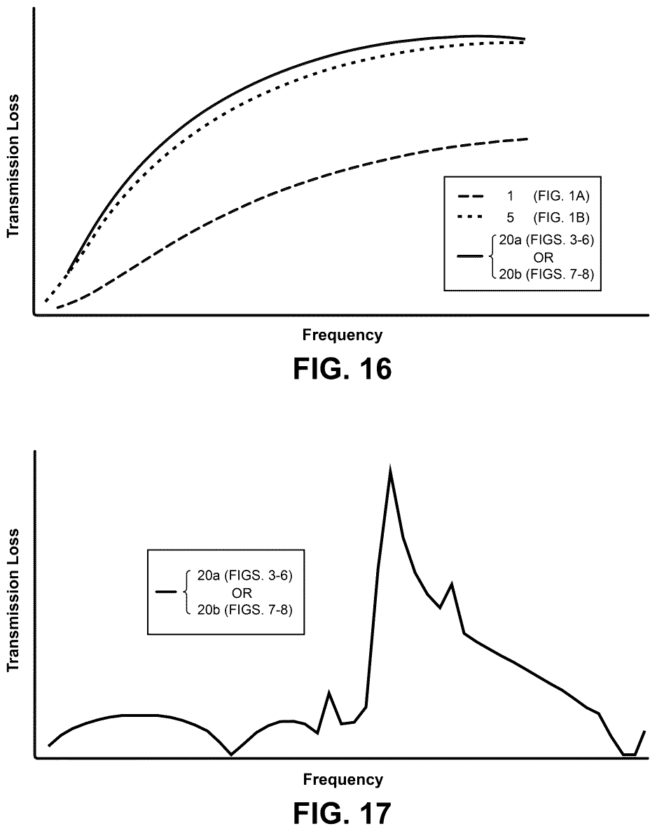

The configuration of the guide walls 40 relative to the walls 21, 22, 23, 24, 25, 26 within the hollow interior 30 of the muffler 20a results in each of the passageways 45 of the muffler 20a having substantially similar flow areas therethrough when flowing in the length direction L along the major surfaces 41, 42 of the guide walls 40 or in the height direction H along each of the manifold spaces 60 while flowing past each of the end surfaces 44 of the guide walls 40, thereby minimizing the pressure drop experienced by the refrigerant when passing therethrough. The disclosed configuration also results in the desired destructive interference of the acoustic waves. Each of the above results is discussed further hereinafter when discussing the test results outlined in the charts of FIGS. 16-18.

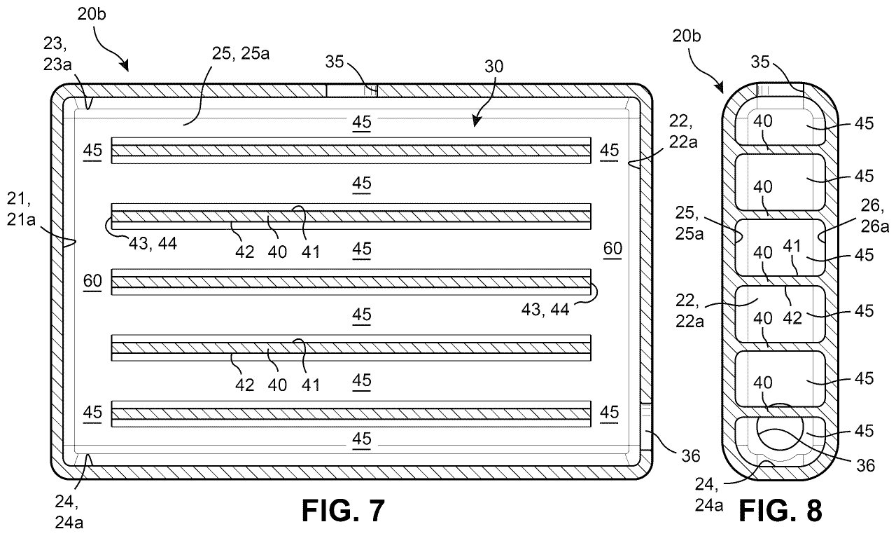

Referring now to FIGS. 7 and 8, a muffler 20b is disclosed according to another embodiment of the present invention. The muffler 20b is identical to the muffler 20a with the exception of the inlet port 35 thereof being repositioned from the first end wall 21 to the upper wall 23, and more specifically, to a central position along the upper wall 23 with respect to the length direction L that is spaced equally from each of the inner surfaces 21a, 22a of the end walls 21, 22. The muffler 20b may be utilized in place of the muffler 20a where an alternative mounting configuration of the muffler 20b is needed relative to the provided packaging space to allow for the fluid line 17 to approach the muffler 20b along the height direction H as opposed to the length direction L, which reduces the total space occupied by an assembly of the muffler 20b and such a fluid line 17 with respect to the length direction L in comparison to an assembly of the muffler 20a and such a fluid line 17. As discussed hereinafter when addressing the charts of FIGS. 16-18, the repositioning of the inlet port 35 as shown and described results in the refrigerant entering the hollow interior 30 along the height direction H while flowing towards the lower wall 24, which results in the flow of the refrigerant (which may be a relatively high-pressure refrigerant as a result of having just been discharged from the compressor 12 according to the disclosed configuration of the exemplary refrigerant circuit 1) initially striking the first major surface 41 of the one of the guide walls 40 facing upwardly towards the upper wall 23 and such that the refrigerant immediately changes direction and thus experiences a greater loss of pressure in comparison to entry of the refrigerant into the muffler 20a, which in contrast includes the major surfaces 41, 42 of the adjacent disposed guide walls 40 arranged in parallel to the flow of the incoming refrigerant such that a immediate change of direction of the refrigerant does not necessarily occur. As discussed later, the performance of the muffler 20b is however not negatively impacted by the change in position of the inlet port 35.

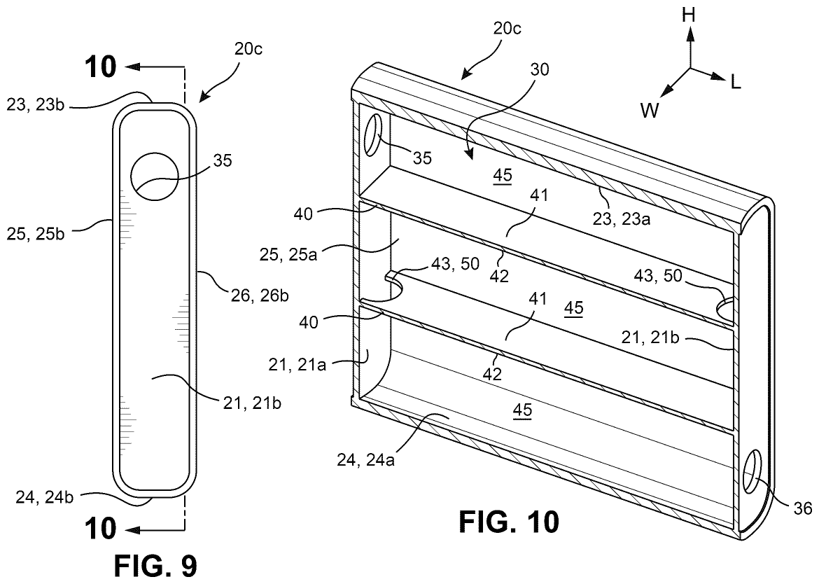

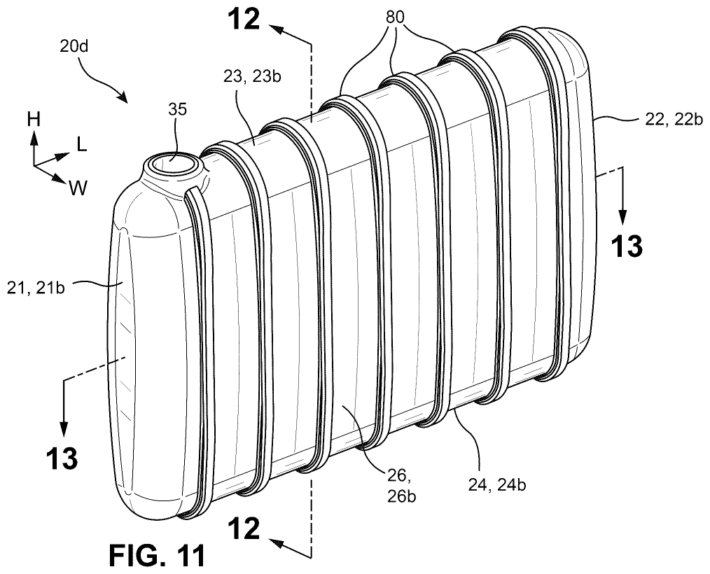

FIGS. 9 and 10 illustrate a muffler 20c according to another embodiment of the present invention having a different configuration of the guide walls 40 in comparison to the mufflers 20a, 20b. In similar fashion to the muffler 20a, the muffler 20c includes the inlet port 35 provided in the first end wall 21 adjacent the junction thereof with the upper wall 23 and the outlet port 36 thereof provided in the second end wall 22 adjacent the junction thereof with the lower wall 24 such that the refrigerant enters and exits the muffler 20c while flowing primarily in the length direction L.

The hollow interior 30 of the muffler 20c includes two of the guide walls 40 disposed therein with each of the guide walls 40 extending laterally between and connected to the inner surfaces 25a, 26a of the opposing lateral side walls 25, 26 with the major surfaces 41, 42 of each of the guide walls 40 extending primarily in the length and width directions L, W, thereby resulting in the major surfaces 41, 42 of the array of guide walls 40 being arranged parallel to one another as well as the inner surfaces 23a, 24a of the upper and lower walls 23, 24. Each of the guide walls 40 is spaced apart from the other one of the guide walls 40 or a facing one of the upper or lower walls 23, 24 with respect to the height direction H. In the present embodiment, each of the guide walls 40 is spaced apart from an adjacent one of the guide walls 40 or a facing one of the inner surfaces 23a, 24a by a common spacing in the height direction H.

In contrast to the guide walls 40 of the mufflers 20a, 20b, the guide walls 40 of the muffler 20c also extend in the length direction L to connect to and extend between the inner surface 21a of the first end wall 21 and the inner surface 22a of the second end wall 22. Each of the guide walls 40 includes a corresponding connecting surface 43 thereof that defines an opening 50 therethrough in cooperation with a facing one of the inner surfaces 21a, 22a of one of the end walls 21, 22. Each of the connecting surfaces 43 may accordingly also be representative of one of the described end surfaces 44, by virtue of each of the connecting surfaces 43 being formed along an end of each such guide wall 40 while facing towards and spaced apart from a corresponding one of the inner surfaces 21a, 22a. The present embodiment includes the uppermost disposed of the two guide walls 40 disposed towards the upper wall 23 having the respective opening 50 formed at the second end wall 22 and the lowermost disposed of the two guide walls 40 disposed towards the lower wall 24 having the respective opening 50 formed at the first end wall 21. Each of the openings 50 is shown as having a semi-circular shape extending away from the corresponding one of the inner surfaces 21a, 22a with a width spacing each opening 50 from the adjacent inner surfaces 25a, 26a of the lateral walls 25, 26, but alternative configurations of the openings 50, including being rectangular-shaped openings 50 formed by spacing the guide walls 40 from each respective inner surface 21a, 22a in similar fashion to the mufflers 20a, 20b, may be utilized without necessarily departing from the scope of the present invention.

The configuration of the muffler 20c results in the formation of a plurality of passageways 45 through the hollow interior 30 that collectively form a serpentine or substantially S-shaped flow path through the muffler 20c where the refrigerant changes flow directions with respect to the length direction L following each turn of the refrigerant in the height direction H when flowing through one of the openings 50 of one of the guide walls 40. The serpentine flow path beneficially provides a configuration wherein acoustic waves are reflected back against oncoming acoustic waves along each of the passageways 45 extending in the length direction as defined between one of the guide walls 40 and one of the upper or lower walls 23, 24 or between adjacent ones of the guide walls 40. The serpentine flow path may be repeated additional times using the same general configuration without necessarily departing from the scope of the present invention.

FIGS. 11-13 illustrate a muffler 20d according to yet another embodiment of the present invention that is substantially similar to the mufflers 20a, 20b in various respects, hence the relevant differences between the mufflers 20a, 20b, 20d are primarily emphasized hereinafter in describing the novel features of the muffler 20d. It can be assumed that any features common to the associated drawing figures associated with each of the similar mufflers 20a, 20b, 20d that are not discussed as being contrary in the muffler 20d in comparison to the mufflers 20a, 20b hereinafter is suitably described with reference to the description of the mufflers 20a, 20b, and thus applies to the muffler 20d.

As shown throughout FIGS. 11-13, one distinction present between the mufflers 20a, 20b and the muffler 20d is that the muffler 20d includes a plurality of ribs 80 disposed on the outer surfaces 23b, 24b, 25b, 26b of the walls 23, 24, 25, 26, wherein each of the ribs 80 is provided as an outwardly projecting portion of each respective outer surface 23b, 24b, 25b, 26b for increasing the area moment of inertia of each of the associated walls 23, 24, 25, 26 and thus the resistance to strain and deformation thereof. In the provided embodiment, each of the ribs 80 extends around a periphery of the muffler 20d as defined by the cooperation of the four contiguous walls 23, 24, 25, 26 such that each of the ribs 80 may be said to curve around an axis extending through the muffler 20d with respect to the length direction L. The inclusion of such ribs 80 may allow for a relatively high-pressure refrigerant or a refrigerant compressed to a relatively high pressure to be utilized in conjunction with the muffler 20d without introducing excessive strain therein, or may additionally allow for the muffler 20d to withstand burst conditions of the refrigerant as may be caused by various different undesirable conditions associated with the refrigerant circuit 10, such as overcharged refrigerant, a faulty expansion element 15, a clogged filter associated with air exchanging heat with the refrigerant, a blockage within the evaporator 16, a malfunction of the compressor 12, or an improper level of refrigerant within the refrigerant circuit 10, as non-limiting examples. The ribs 80 may be provided to extend along only certain portions or certain ones of the outer surfaces 23b, 24b, 25b, 26b, or may additionally be included along the outer surfaces 21b, 22b in similar fashion without departing from the scope of the present invention, so long as the ribs 80 provide strength and durability to the desired portions of the corresponding walls 21, 22, 23, 24, 25, 26. The ribs 80 may also be provided at different orientations, such as extending around an axis extending in the height direction H without departing from the scope of the present invention. Although shown only with respect to the muffler 20d, the present invention is inclusive of the use of such ribs 80 in the same manner as shown and described on the outer surfaces 21b, 22b, 23b, 24b, 25b, 26b of any of the mufflers 20a, 20b, 20c previously described herein according to additional embodiments of the present invention.

The muffler 20d also differs slightly from each of the mufflers 20a, 20b, 20c in that each of the walls 21, 22, 23, 24, 25, 26 and each of the transitions at junctions between adjacent ones of the walls 21, 22, 23, 24, 25, 26 include more curvature to result in increased convexity along the outer surfaces 21b, 22b, 23b, 24b, 25b, 26b and transitions therebetween and corresponding increased concavity along the inner surfaces 21a, 22a, 23a, 24a, 25a, 26a and transitions therebetween. In fact, the end walls 21, 22 and the upper and lower walls 23, 24 include shapes that are substantially semi-circular in configuration while still extending primarily in the previously designed primary directions of extension, whereas the lateral walls 25, 26 include a slight convexity along the outer surfaces 25b, 26b thereof and a correspondingly slight concavity along the inner surfaces 25a, 26a thereof, as can best be appreciated from review of FIG. 11. Such arcuate surfaces and transitions reduce an incidence of sharp interior corners within the muffler 20d that would otherwise tend to lead to localized stress risers within the muffler 20d at such sharp interior corners. Such arcuate surfaces and transitions tend to distribute internal pressure forces more evenly than such sharp corners, thereby leading to increased strength and durability of the muffler 20d. Once again, although thus far only shown with respect to the muffler 20d, the present invention is inclusive of the use of such concavity and opposing convexity in the same manner as shown and described with respect to any of the walls 21, 22, 23, 24, 25, 26 of any of the mufflers 20a, 20b, 20c previously described herein according to additional embodiments of the present invention.

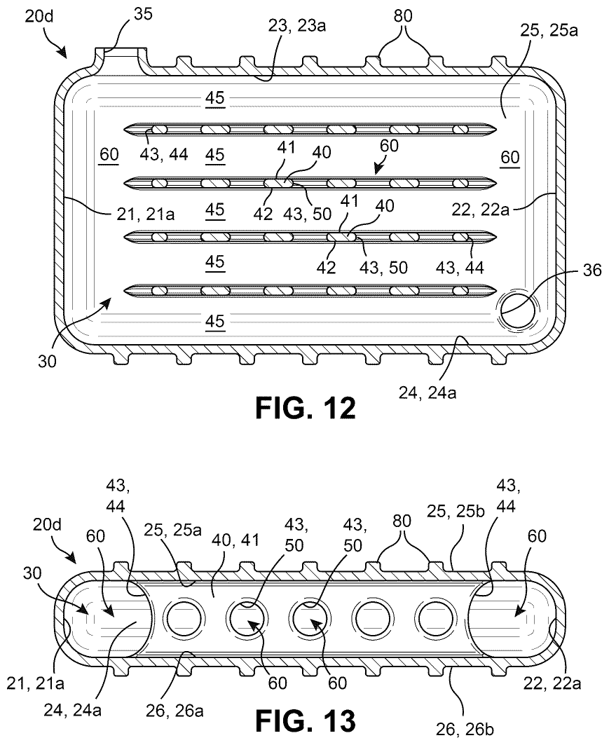

The muffler 20d also includes a distinct configuration of the inlet port 35 and the outlet port 36 thereof in comparison to the previously described mufflers 20a, 20b, 20c. Specifically, the inlet port 35 is provided in the upper wall 23 immediately adjacent the first end wall 21 while the outlet port 36 is provided adjacent a corner of the first lateral wall 25 at which the first lateral wall 25 adjoins each of the second end wall 22 and the lower wall 24. The inlet port 35 is accordingly oriented to cause the refrigerant to enter the muffler 20d while flowing along the height direction H towards the lower wall 24 while the outlet port 36 is oriented to cause the refrigerant to experience a 90 degree turn immediately before exiting the muffler 20 d while flowing in the width direction W away from the second lateral wall 26 and towards the first lateral wall 25. Such a variation may be utilized where an alternative configuration of the fluid lines 17, 18 relative to the muffler 20d is necessary or desirable in accordance with the configuration of the refrigerant circuit 10 and/or the provided packaging space. Additionally, as can be seen in each of FIGS. 12 and 13, the position and orientation of the inlet port 35 allows for the refrigerant to be delivered initially to an open space within the hollow interior 30 forming one of the manifold spaces 60 such that the refrigerant does not encounter a transverse surface in a manner lowering the pressure of the refrigerant as described with respect to the muffler 20b. Such a configuration promotes the ability of the refrigerant to be distributed to the different passageways 45 extending in the length direction of the muffler 20d and towards the outlet port 36.

In similar fashion to the mufflers 20a, 20b, the muffler 20d includes an array of the guide walls 40 that extend between the lateral walls 25, 26 while spaced apart from each other and/or a respective facing upper or lower wall 23, 24 of the muffler 20d with respect to the height direction H to form the above mentioned passageways 45 extending in the length direction L. The array of the guide walls 40 of the muffler 20d also similarly includes each of the guide walls 40 spaced apart from the opposing inner surfaces 21a, 22a of the end walls 21, 22 in a manner forming a first one of the manifold spaces 60 between the aligned end surfaces 44 of a first end of each of the guide walls 40 and the facing inner surface 21a while also forming a second one of the manifold spaces 60 between the aligned end surfaces 44 of a second end of each of the guide walls 40 and the facing inner surface 22a. However, the end surfaces 44 of the muffler 20d differ from the planar end surfaces 44 extending in the height and width directions H, W of the mufflers 20a, 20b in that the end surfaces 44 of the muffler 20d include curvature about an axis extending in the height direction H that substantially mimics the curvature of a facing one of the inner surfaces 21a, 22a of a corresponding one of the end walls 21, 22 to result in the formation of each of the manifold spaces 60 to be more circular or rounded-rectangular in configuration, which again eliminates the formation of sharp corners where the end surfaces 44 merge with the inner surfaces 25a, 26a of the lateral walls 25, 26 for reducing an incidence of stress risers via a more even distribution of the forces resulting from the internal pressure of the refrigerant.

Lastly, each of the guide walls 40 of the muffler 20d differs from those of the mufflers 20a, 20b in that each of the guide walls 40 includes additional connecting surfaces 43 defining a plurality of openings 50 within each of the guide walls 40. The openings 50 extend through each of the guide walls 40 with respect to the height direction H and are spaced apart from one another (equally as shown) with respect to the length direction L along each respective guide wall 40. The openings 50 may include circular perimeter shapes with arcuate transitions to each of the major surfaces 41, 42 about each such perimeter to once again promote stress distributing surfaces devoid of undesirably sharp corners. Each of the respective openings 50 when progressing along the guide walls 40 in the length direction L are aligned with corresponding openings of the remaining guide walls 40 to result in the formation of multiple of the manifold spaces 60 within the array of the guide walls 40, wherein each such manifold space 60 extends along an axis extending in the height direction H through all such aligned openings 50.

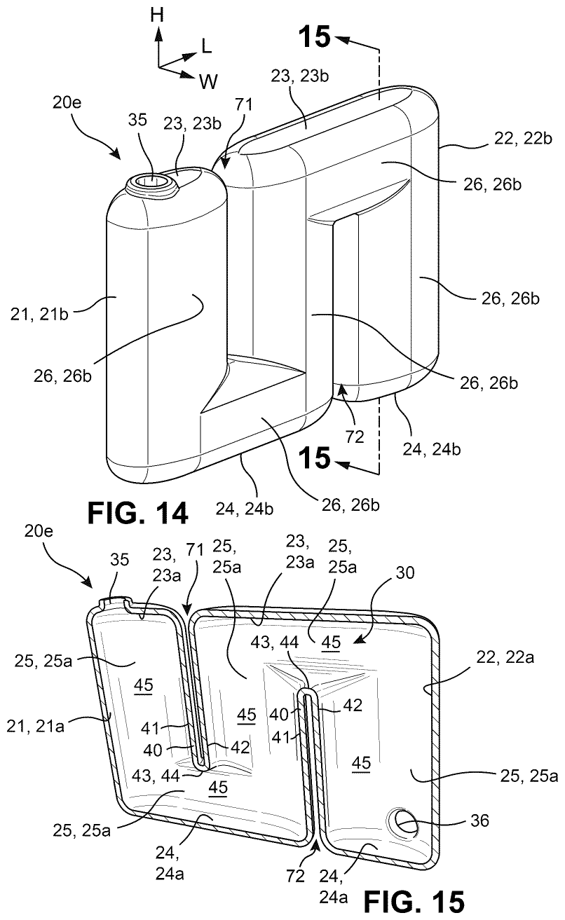

Referring finally to FIGS. 14 and 15, a muffler 20e according to another embodiment of the present invention is disclosed, wherein the muffler 20e includes various features previously disclosed with reference to each of the mufflers 20c, 20d in combination, wherein the descriptions of such features with regards to either of the mufflers 20c, 20d applies to those features identified as similar with respect to the muffler 20e where not described in great detail hereinafter. The muffler 20e is similar to the muffler 20d in that the inlet port 35 and the outlet port 36 are similarly positioned and oriented within the upper wall 23 and the first lateral wall 25, respectively, for prescribing respective entry of the refrigerant in the height direction H towards the lower wall 24 and lateral exiting of the refrigerant in the width direction W following a 90 degree turn away from the second lateral wall 26 and towards the first lateral wall 25. The muffler 20e also shares similar curvature along the various walls 21, 22, 23, 24, 25, 26 and transitions therebetween, including substantially semi-circular or semi-elliptical surfaces along various walls 21, 22, 23, 24, 25, 26 and transitions therebetween for improving a distribution of forces resulting from the internal pressure of the refrigerant.

One clear distinction in the muffler 20e from the prior embodiments 20a, 20b, 20c, 20d corresponds to the muffler 20e including a first indentation 71 formed in the outer surface 23b of the upper wall 23 across an entire width of the muffler 20e as well as a second indentation formed in the outer surface 24b of the lower wall 24 across an entire width of the muffler 20e, wherein the first indentation 71 is indented into the upper wall 23 in the height direction H towards the lower wall 24 while the second indentation 72 is indented into the lower wall 24 in the height direction H towards the upper wall 23. The width-wise extension of each of the indentations 71, 72 results in each of the upper and lower walls 23, 24 being segmented into two portions spaced apart by the length direction L while each of the lateral walls 25, 26 is segmented into five distinct legs that together cooperate to form a substantially S-shaped serpentine configuration of each of the lateral walls 25, 26.

As shown in FIG. 15, the presence of the indentations 71, 72 results in the formation of two of the guide walls 40 within the hollow interior 30 of the muffler 20e that in contrast to the previously described mufflers 20a, 20b, 20c, 20d include the major surfaces 41, 42 thereof arranged in the height direction H while extending between the opposing lateral walls 25, 26. Each such guide wall 40 also includes a connecting surface 43 provided as an end surface 44 of each respective guide wall 40 that extends in the length direction L and is spaced apart from a respectively facing one of the lower wall 24 or the upper wall 23 to form respective passageways 45 therebetween. The muffler 20e further includes respective passageways 45 formed between each of the first end wall 21 and a first one of the guide walls 40, the first one of the guide walls 40 and an adjacent second one of the guide walls 40, and the second end wall 22 and the second one of the guide walls 40. The muffler 20e accordingly includes the hollow interior 30 having a similar serpentine or S-shaped flow path for the refrigerant in the same manner as the muffler 20c, although with significantly more arcuate or rounded transitions present between each of the associated passageways 45 thereof.

Referring now briefly to the charts of FIGS. 16 and 17, testing results regarding each of the mufflers 20a, 20b having the similar constructions but with varying positions and orientations of the respective inlet ports 35 thereof are shown. In FIG. 16, each of the mufflers 20a, 20b of the present invention as well as representative examples of each of the mufflers 1, 5 of the prior art as shown and described herein were tested along a range of relatively low operating frequencies (less than 200 Hz) to determine the acoustic transmission loss achieved by each of the mufflers 20a, 20b with respect to such operating frequencies, wherein the mufflers 20a, 20b of the present invention and the mufflers 1, 5 of the prior art were selected to occupy substantially similar packaging spaces within a corresponding vehicle. Despite the mufflers 20a, 20b of the present disclosure having the contrary inlet port 35 configurations, the curves of each of the mufflers 20a, 20b were indistinguishable from one another such that the results of each of the mufflers 20a, 20b are shown as a single curve representative of either of the mufflers 20a, 20b. As is evident from review of FIG. 16, the mufflers 20a, 20b show considerable improvement in the tested transmission loss in comparison to the elongate muffler 1 of FIG. 1A having the axial flow through of the refrigerant, including doubling the resulting transmission loss at many frequencies in comparison thereto. The mufflers 20a, 20b also show a slight improvement in transmission loss in comparison to the muffler 5 of FIG. 1B having the 90 degree turn of the refrigerant therein, thereby indicating the suitability of such mufflers 20a, 20b as replacements for either such conventional mufflers 1, 5 of the prior art with respect to a comparable packaging space occupied by each of the tested configurations of the mufflers 1, 5, 20a, 20b. As mentioned in the background of the present invention, such relatively low operating frequencies may be associated with the use of a scroll compressor, hence the embodiments 20a, 20b of the present invention are well suited as replacements for the conventional mufflers 1, 5 when used in conjunction with such a scroll compressor or other compressor configured to operate as such relatively low frequencies, and especially when a limited packaging space is available within the associated vehicle at the desired position of the muffler along a corresponding refrigerant circuit of the vehicle.

FIG. 17 is a chart again showing a plot of transmission loss vs operating frequency along an expanded range of frequencies with respect to only the mufflers 20a, 20b of the present invention, which again are shown as a single curve representative of either of the mufflers 20a, 20b due to the results being indistinguishable therebetween, wherein the testing in FIG. 17 occurred with respect to R1234YF refrigerant. In addition to having desirable transmission loss at the relatively low frequencies (less than 200 Hz) that may be associated with certain modes of operation of the corresponding compressor 12 and refrigerant circuit 10, the mufflers 20a, 20b also show excellent transmission loss with respect to moderate to high frequencies of operation that may be associated with the use of compressors that typically operate at higher frequencies than a typical scroll compressor, such as the rotary compressors described in the background of the present invention. The mufflers 20a, 20b can accordingly attenuate noise in a desirable manner with respect to multiple different ranges of frequencies that may be encountered during use of such mufflers 20a, 20b in conjunction with a variety of different compressor types while also appreciating the benefits described herein regarding the ability to install such mufflers 20a, 20b within various relatively narrow packaging spaces, such as those packaging spaces that are substantially rectangular cuboid in configuration with a relatively small minor dimension corresponding to the width direction W in the present examples.

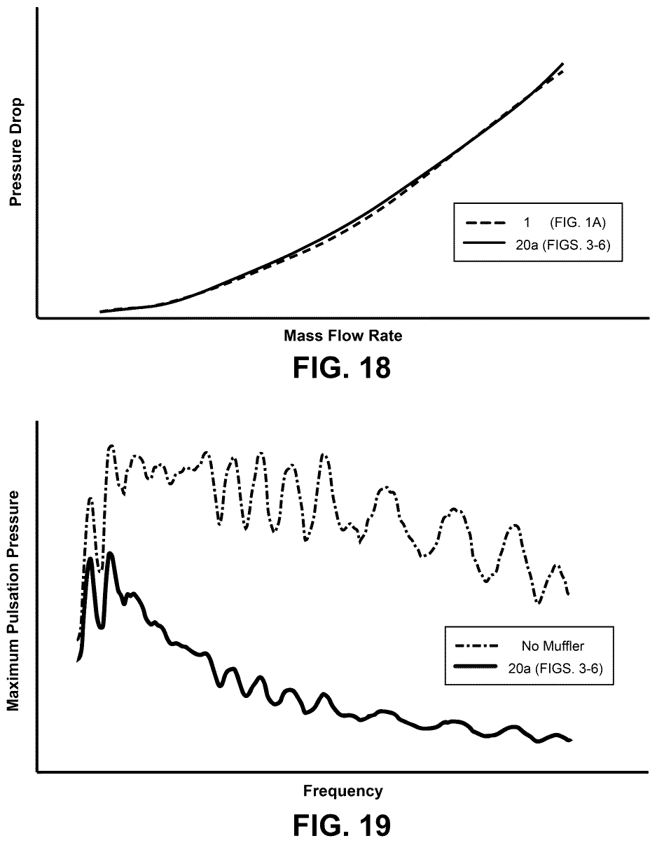

FIG. 18 shows a comparison of testing results present between the muffler 20a of the present invention and the representative elongate muffler 1 of the prior art with respect to a plotting of the pressure drop experienced by R1234YF refrigerant in comparison to a range of mass flow rates of the refrigerant through each corresponding muffler 1, 20a. The muffler 20a includes almost an identical curve to the muffler 1 of the prior art having the axial flow through configuration along the entire range of tested mass flow rates, once again indicating that the muffler 20a is well suited as a replacement for the muffler 1 in an associated refrigerant circuit, and especially where a limited packaging space is available.

FIG. 19 shows a comparison of testing results present between testing of a refrigerant circuit having the muffler 20a and testing of the same refrigerant circuit devoid of any form of refrigerant muffler, wherein the chart of FIG. 19 shows a plotting of the maximum pressure value of each pressure pulsation occurring with respect to a range of relatively low frequencies (less than 200 Hz) as measured at a position immediately upstream of a corresponding condenser (after having passed through the muffler 20a) of the associated refrigerant circuit. As can be readily seen in FIG. 19, the muffler 20a significantly smooths out the flow of the refrigerant after passing therethrough such that the maximum pressure values associated with each pressure pulse are generally less than half as great as those experienced when no refrigerant muffler is utilized, and often one third to one quarter as great towards the higher range of the tested frequencies. Such a reduction in the maximum pressure associated with each such pressure pulsation leads to each of less noise propagation through the corresponding refrigerant circuit, improved heat exchange efficiency of the corresponding refrigerant circuit due to a more constant and consistent flow of the refrigerant therethrough, and improved durability of the components forming the corresponding refrigerant circuit as a result of lower stresses being encountered within such components as a result of the lowered maximum internal pressures applied by the refrigerant to such components.

The muffler 20a accordingly shows a similar (and slightly improved) ability to attenuate noise in comparison to the muffler 5 and a dramatically improved ability to attenuate noise in comparison to the muffler 1 along the (relatively low) range of tested frequencies, as indicated in FIG. 16. The muffler 20a also shows nearly identical capabilities as the muffler 1 in preventing pressure loss, as indicated in FIG. 18. As disclosed in FIG. 17, the mufflers 20a, 20b are also able to be utilized in conjunction with a compressor operating at relatively moderate to high frequencies (in addition to those frequencies described herein as being relatively low frequencies as may be experienced when used in conjunction with a scroll compressor), thereby indicating that the mufflers 20a, 20b may be adapted for use with respect to essentially any refrigerant circuit and corresponding compression means via appropriate tuning of such mufflers 20a, 20b to the desired ranges of frequencies. The muffler 20a has also been demonstrated as greatly reducing the maximum pressure values experienced downstream of the corresponding compressor as a result of the pressure pulsations emanating therefrom, as indicated in FIG. 19. The mufflers 20a, 20b are accordingly advantageous replacements for either of the mufflers 1, 5 of the prior art while also having a narrower profile for facilitating an ease of installation of the mufflers 20a, 20b within a corresponding packaging space of a vehicle, regardless of the type of compressor utilized in conjunction therewith.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A refrigerant muffler comprising:
a plurality of outer walls forming an outer surface of the refrigerant muffler and enclosing a hollow interior thereof, each of the respective outer walls forming a pair with an oppositely arranged one of the outer walls at opposing sides of the hollow interior;
an inlet port provided in a first one of the respective outer walls through which a refrigerant is introduced into the hollow interior of the refrigerant muffler; and
an outlet port provided in a second one of the respective outer walls through which the refrigerant exits the hollow interior of the refrigerant muffler;
wherein the refrigerant muffler does not include a cross-section therethrough where the outer surface of the refrigerant muffler has a circular shape comprised of both of the outer walls forming one of the pairs of the oppositely arranged outer walls.

2. The refrigerant muffler of claim 1, wherein the refrigerant muffler does not include a cross-section therethrough wherein a portion of the outer surface of the refrigerant muffler both has a constant radius of curvature extending through greater than 180 degrees of angular displacement and is comprised of both of the outer walls forming one of the pairs of the oppositely arranged outer walls.

3. The refrigerant muffler of claim 1, wherein the outer surface of the refrigerant muffler does not include a portion thereof that is both cylindrical in shape and comprised of both of the outer walls forming one of the pairs of the oppositely arranged outer walls.

4. The refrigerant muffler of claim 1, wherein a direction the refrigerant is introduced into the hollow interior of the refrigerant muffler through the inlet port is transverse to a direction the refrigerant exits the hollow interior through the outlet port.

5. The refrigerant muffler of claim 4, wherein the first one of the outer walls in which the inlet port is provided and the second one of the outer walls in which the outlet port is provided are connected to one another along a periphery of the outer surface of the refrigerant muffler.

6. The refrigerant muffler of claim 1, wherein a direction the refrigerant is introduced into the hollow interior of the refrigerant muffler through the inlet port is parallel to a direction the refrigerant exits the hollow interior through the outlet port.

7. The refrigerant muffler of claim 6, wherein the first one of the outer walls in which the inlet port is provided and the second one of the outer walls in which the outlet port is provided form one of the pairs of the oppositely arranged outer walls.

8. The refrigerant muffler of claim 1, further comprising at least one guide wall disposed within the hollow interior with each of the at least one guide walls extending between one of the pairs of the oppositely arranged outer walls and configured to divert a flow of the refrigerant and/or to reflect acoustic waves associated with the flow of the refrigerant.

9. The refrigerant muffler of claim 8, wherein the one of the pairs of the oppositely arranged outer walls between which the at least one guide wall extends includes the closest spacing between the oppositely arranged outer walls thereof among all of the pairs of the oppositely arranged outer walls forming the outer surface of the refrigerant muffler.

10. The refrigerant muffler of claim 8, wherein the at least one guide wall includes a connecting surface extending across a thickness of the at least one guide wall to allow passage of the flow of the refrigerant and/or the acoustic waves associated therewith between a first major surface of the at least one guide wall and an oppositely arranged second major surface of the at least one guide wall.

11. The refrigerant muffler of claim 10, wherein the connecting surface is formed by one of an end surface of the at least one guide wall or a surface defining an opening through the at least one guide wall.

12. The refrigerant muffler of claim 8, wherein the at least one guide wall includes a plurality of the guide walls arranged to divert the flow of the refrigerant and/or the acoustic waves associated therewith through a serpentine flow path between the inlet port and the outlet port.

13. The refrigerant muffler of claim 8, wherein the at least one guide wall includes a plurality of the guide walls spaced apart from one another to form a plurality of passageways through the hollow interior for conveying the flow of the refrigerant and/or the acoustic waves associated therewith therethrough.

14. The refrigerant muffler of claim 13, wherein each of the plurality of the guide walls includes an end surface thereof spaced apart from a facing one of the outer walls to form a manifold space by cooperation of the facing one of the outer walls and each of the end surfaces of the plurality of the guide walls, wherein the manifold space is directly fluidly coupled to each of the plurality of the passageways.

15. The refrigerant muffler of claim 13, wherein each of the plurality of the guide walls includes an opening formed through a thickness thereof for conveying the flow of the refrigerant and/or the acoustic waves associated therewith from one of the plurality of the passageways to another of the plurality of the passageways.

16. The refrigerant muffler of claim 15, wherein a manifold space is formed by the cooperation of a plurality of the openings respectively associated with different ones of the plurality of the guide walls aligning along a single axis arranged parallel to the thickness direction of each of the guide walls, wherein the manifold space is directly fluidly coupled to each of the plurality of the passageways.

17. The refrigerant muffler of claim 1, wherein the plurality of the outer walls includes three of the pairs of the oppositely arranged outer walls formed into a substantially rectangular cuboid shape.

18. The refrigerant muffler of claim 16, wherein the rectangular cuboid shape is divisible into four quadrants with the inlet port provided in a first one of the quadrants and the outlet port provided in a second one of the quadrants disposed diagonally across the rectangular cuboid shape relative to the first one of the quadrants.

19. A refrigerant muffler comprising:
six outer walls arranged into a substantially rectangular cuboid shape enclosing a hollow interior of the refrigerant muffler, the six outer walls including a first end wall and an oppositely arranged second end wall, an upper wall and an oppositely arranged lower wall, and a first lateral wall and an oppositely arranged second lateral wall, wherein each of the first lateral wall and the second lateral wall are connected around a respective periphery thereof to each of the first end wall, the second end wall, the upper wall, and the lower wall;
an inlet port provided in one of the first end wall or the upper wall through which a refrigerant is introduced into the hollow interior of the refrigerant muffler;
an outlet port provided in one of the second end wall or the first lateral wall through which the refrigerant exits the hollow interior of the refrigerant muffler; and
a plurality of guide walls extending between the first lateral wall and the second lateral wall, each of the plurality of the guide walls arranged in parallel and spaced apart from each other in a direction perpendicular to a direction of parallel extension of the plurality of the guide walls, each of the plurality of the guide walls configured to divert a flow of the refrigerant and/or to reflect acoustic waves associated with the flow of the refrigerant.

20. A refrigerant circuit including, in an order of flow of a refrigerant during circulation thereof through the refrigerant circuit, a compressor, a refrigerant muffler, a condenser, an expansion element, and an evaporator, the refrigerant muffler comprising:
a plurality of outer walls forming an outer surface of the refrigerant muffler and enclosing a hollow interior thereof, each of the respective outer walls forming a pair with an oppositely arranged one of the outer walls at opposing sides of the hollow interior;
an inlet port provided in a first one of the respective outer walls through which a refrigerant discharged from the compressor is introduced into the hollow interior of the refrigerant muffler; and
an outlet port provided in a second one of the respective outer walls through which the refrigerant exits the hollow interior of the refrigerant muffler towards the condenser;
wherein the refrigerant muffler does not include a cross-section therethrough where the outer surface of the refrigerant muffler has a circular shape comprised of both of the outer walls forming one of the pairs of the oppositely arranged outer walls.
